(19) United States
(12) Patent Application Publication
(10) Pub. No.: US 2004/0001153 A1
(43) Pub. Date: Jan. 1, 2004

(54) Camera system

(75) Inventors: Youichi Kikukawa, Tokyo (JP); Tooru Katsurai, Tokyo (JP); Kenji Fujino, Tokyo (JP); Takahiro Takahashi, Tokyo (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: Yokogawa Electric Corporation, Tokyo (JP)

(21) Appl. No.: 10/443,827

(22) Filed: May 23, 2003

(30) Foreign Application Priority Data
Jun. 26, 2002 (JP) 2002-185445
Jan. 17, 2003 (JP) 2003-009533

(51) Int. Cl. H04N 9/73

(52) U.S. Cl. 348/226.1

(57) ABSTRACT

The object of the present invention is to realize a camera system that can suppress the influence of flickering.

The present invention is characterized by comprising:

a photographing part that generates image data from image sensors using the rolling shutter method, and

a calculating part which receives image data from said photographing part as input, calculates average values of the image data, which generate lateral stripes of flickering the phases of which are shifted about 180 degrees relative to each other, for each pixel, and the calculated results are employed as the image data.

### BACKGROUND OF THE INVENTION

1. Field of the Invention

The present invention relates to a camera system which generates image data from image sensors using the rolling shutter method, and in particular, to a camera system which can suppress the influence of flickering.

2. Description of the Prior Art

As image sensors that acquire photographic subjects in a digital form, there are Charge-Coupled Devices (CCD) sensors and Complementary Metal-Oxide Semiconductor (CMOS) sensors. A CMOS sensor is, for example, mentioned in “A 256×256 CMOS Imaging Array with Wide Dynamic Range Pixels and Column-Parallel Digital Output,” reported by Steven Decker, R. Daniel McGrath, Kevin Brehmer, and Charles G. Sodini in IEEE JOURNAL OF SOLID-STATE CIRCUITS, Vol.33, No.12, DECEMBER 1998.

A CMOS imager using such CMOS sensors will be described using FIG. 1 and FIG. 2. In FIG. 1, a plurality of CMOS sensors 1 is provided for each color filter, namely red (R), green (G), and blue (B). A plurality of controllers 2 is provided for each line of CMOS sensors, and controls timings for CMOS sensors 1. A plurality of A/D converters 3 is provided for every two columns of CMOS sensors and converts the output of CMOS sensors 1 to digital data. Multiplexer 4 selects the output of A/D converters 3 and outputs them as image data.

FIG. 2 is a drawing showing a tangible configuration of a CMOS sensor 1. In FIG. 2, the cathode of photodiode PD is grounded. One end of resistor R is connected to the anode of photodiode PD. One end of capacitor C is connected to the other end of resistor R and the other end of capacitor C is grounded. A control signal from controller 2 is input to the gate of Field Effect Transistor (FET) Q1 the drain of which is connected to a voltage Vdd and the source is connected to the above one end of capacitor C. The gate of FET Q2 is connected to the above one end of capacitor C and its drain is connected to voltage Vdd. A selecting signal of controller 2 is input to the gate of FET Q3 the drain of which is connected to the source of FET Q2 and its source is connected to A/D converter 3.

The operation of such a device will be described below. First, the operation of the CMOS imager is described using FIG. 3.

CMOS sensor 1 is selected from the bottom line by controller 2, and A/D converter 3 outputs the output of CMOS sensor 1 after converting it to digital data. When controller 2 resets the pixels of the bottom line, controller 2 simultaneously selects CMOS sensor 1 located in a line one line above the bottom line, and A/D converter 3 converts the output of CMOS sensor 1 to digital data. In this case, multiplexer 4 outputs data in turn from the left side to the right side. Simultaneous with the resetting of CMOS sensor 1 located in the second line from the bottom, accumulation of the photoelectrons of CMOS sensor 1 located in the bottom line is started.

As described above, operation is continued in turn from the lower line to the upper line. Since the timing of exposures continues to shift little by little towards the upper part of the screen from the bottom, this is called the rolling shutter method. The exposure time in this method is adjusted by increasing or decreasing the photoelectron accumulation period, and to keep the frame rate constant, control is executed so that the total sum of the accumulation time and data reading and resetting times in each line composes the updating time for one frame of the screen.

Next, operation of CMOS sensor 1 will be described using FIG. 4. In FIG. 4, the ordinate indicates the values of voltage, intensity of light or electric charge and the abscissa indicates time; and also ‘a’ indicates the control signal, ‘b’ the incident light from a fluorescent lamp, and ‘c’ the electric charge of capacitor C. In FIG. 4, for the purpose of easily imagining a CMOS sensor 1 operation, control signal ‘a’ and electric charge ‘c’ are indicated inversely with the actual values in CMOS sensor 1. That is, the high and low levels of control signal ‘a’ are inverted and electric charge ‘c’ operates decreasingly not increasingly.

At instant t0, a control signal ‘a’ (low level) is input from controller 2 to the gate of FET Q1 and FET Q1 enters the off-state. As a result, photodiode PD acquires an electric charge which has been charged from capacitor C. This results in the decrease of electric charge ‘c’. The voltage corresponding to this electric charge ‘c’ is applied to the gate of FET Q2.

At instant t1, a selecting signal is input from controller 2 to the gate of FET Q3 and is output to A/D converter 3. Control signal ‘a’ (high level) is input to the gate of FET Q1, FET Q1 enters the on-state, and capacitor C is charged.

At instant t2, control signal ‘a’ (low level) is input to the gate of FET Q1 from controller 2 and so FET Q1 enters the off-state. As a result, photodiode PD acquires an electric charge which has been charged from capacitor C due to incident light ‘b’. This results in the decrease of electric charge ‘c’. Operations such as described above are repeated.

If the extraneous light is constant, no problem is generated. However, if an object illuminated with a light source that flickers due to supply frequency such as a fluorescent light is viewed, a phenomenon is generated, in spite of viewing the same photographic subject, in which the output of pixels increases or decreases depending on the frames as shown with electric charge ‘c’. This is due to the period of flickering of the light source and the timing for the electric charge accumulation (discharge) of the image sensor. This appears as lateral stripes on the screen. Such lateral stripes are not generated for the CCD sensor which does not require the rolling shutter method. However, this flickering of lateral stripes cannot be prevented in conventional CMOS sensor 1 which uses the rolling shutter method.

Next, another example of operation will be described using FIG. 5. In FIG. 5, as identical to FIG. 4, the ordinate indicates the values of voltage, intensity of light or electric charge and the abscissa indicates time; and also ‘a’ indicates the control signal, ‘b’ the incident light from a fluorescent lamp, and ‘c’ the electric charge of capacitor C. In FIG. 5, as identical to FIG. 4, control signal ‘a’ and electric charge ‘c’ are also indicated inversely with the actual values in CMOS sensor 1.

At instant t0, control signal ‘a’ is input to the gate of FET Q1 and FET Q1 limits stepwise electric charge supplied to capacitor C from voltage Vdd. As a result, photodiode PD acquires an electric charge which has been charged from capacitor C due to incident light ‘b’. This results in the decrease of electric charge ‘c’. The voltage corresponding to this electric charge ‘c’ is applied to the gate of FET Q2.

At instant t1, a selecting signal is input from controller 2 to the gate of FET Q3 and is output to A/D converter 3. Control signal ‘a’ is input to the gate of FET Q1, FET Q1 enters the on-state, and capacitor C is charged.

At instant t2, control signal ‘a’ is input to the gate of FET Q1 and FET Q1 limits stepwise electric charge supplied to capacitor C from voltage Vdd. As the result, photodiode PD acquires an electric charge which has been charged from capacitor C due to incident light ‘b’. This results in the decrease of electric charge ‘c’. Operations such as described above are repeated.

As described above, the wide dynamic range of CMOS sensor 1 is really obtained by varying control signal ‘a’. However, when the voltage given to the gate of FET Q1 is minimum (maximum in FIG. 5), the electric charge accumulation greatly changes depending on the intensity of incident light ‘b’ from the fluorescent lamp and thus the influence of flickering becomes large.

### SUMMARY OF THE INVENTION

The object of the present invention is to achieve a camera system which can suppress the influence of flickering.

### BRIEF DESCRIPTION OF THE DRAWINGS

FIG. 1 is a drawing indicating a conventional CMOS imager configuration.

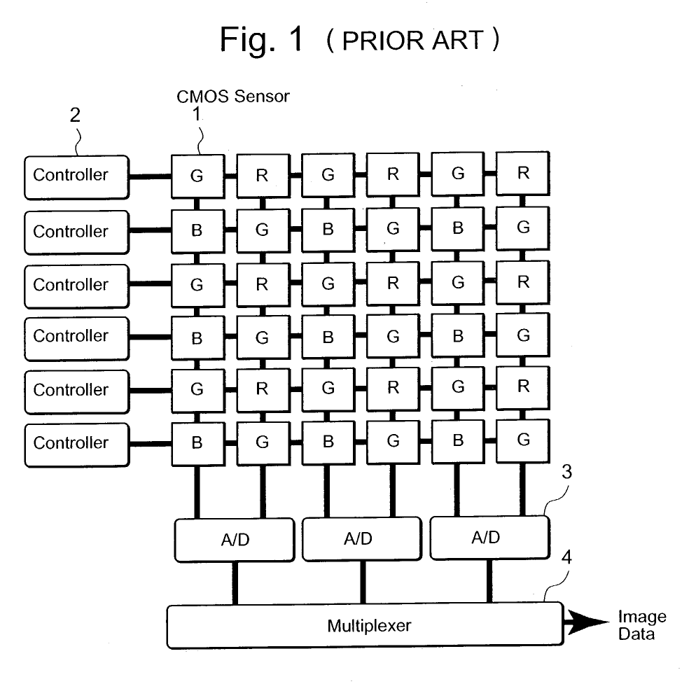

FIG. 2 is a drawing showing a tangible configuration of CMOS sensor 1 in a conventional CMOS imager.

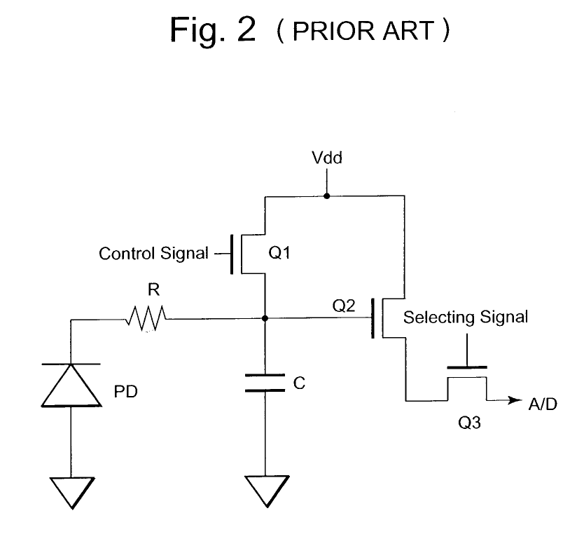

FIG. 3 is a drawing illustrating the operation of a conventional CMOS imager.

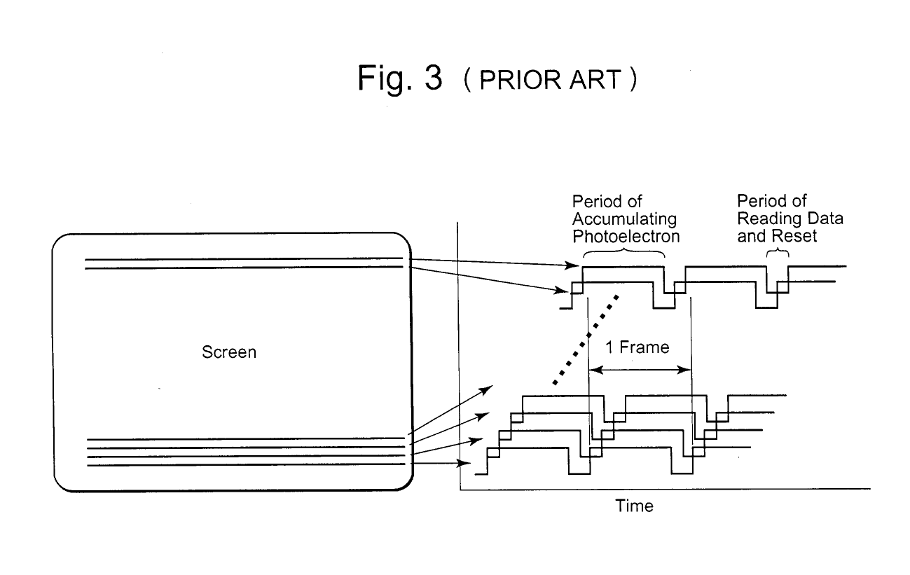

FIG. 4 is a drawing illustrating the operation of CMOS sensor 1 shown in FIG. 2.

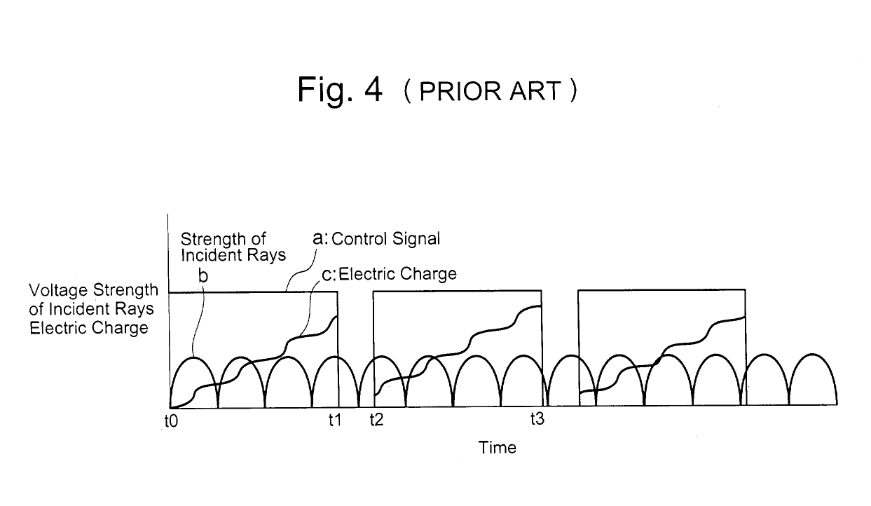

FIG. 5 is a drawing illustrating the operation of CMOS sensor 1 shown in FIG. 2.

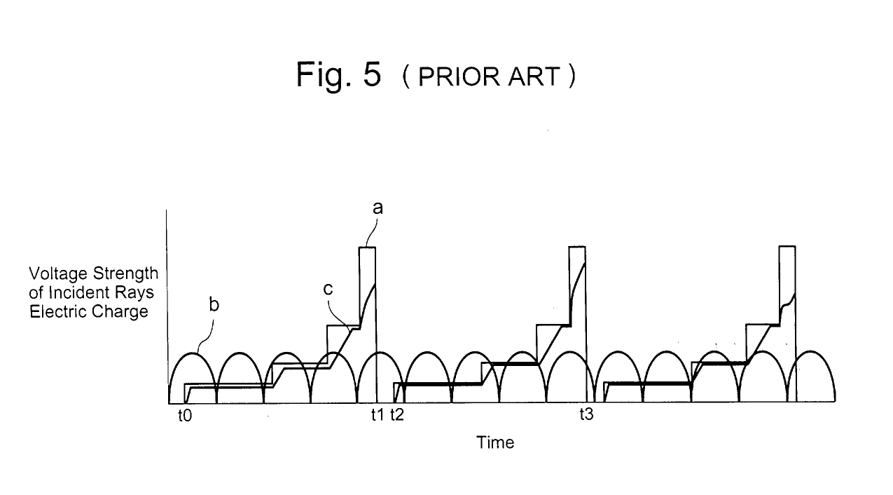

FIG. 6 is a configuration drawing indicating a first embodiment of the present invention.

FIG. 7 is a drawing illustrating the operation of the system shown in FIG. 6.

FIG. 8 is a configuration drawing indicating a second embodiment of the present invention.

FIG. 9 is a configuration drawing indicating a third embodiment of the present invention.

FIG. 10 is a drawing illustrating the operation of the system shown in FIG. 9.

FIG. 11 is a configuration drawing indicating a fourth embodiment of the present invention.

FIG. 12 is a drawing illustrating the operation of the system shown in FIG. 11.

### DETAILED DESCRIPTION OF THE PREFERRED EMBODIMENTS

Embodiments of the present invention will be described below using the drawings.

(First Embodiment)

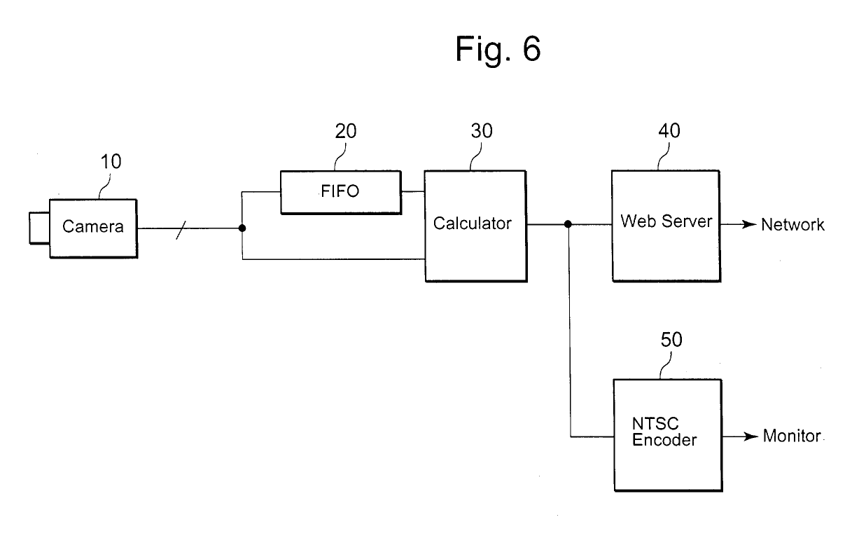

FIG. 6 is a configuration drawing indicating a first embodiment of the present invention.

In FIG. 6, camera 10 composes a photographing part, generates image data from image sensors (CMOS sensors) using the rolling shutter method, and in turn outputs image data generating flickering lateral stripes, the phases of which are shifted about 180 degrees relative to each other. These image data the phases of which are shifted about 180 degrees relative to each other can be realized by selecting the frame rate appropriately. First-In First-Out (FIFO) memory 20 is a temporary memory and receives image data from camera 10 as input and temporarily stores them. Calculator 30 receives the image data from FIFO memory 20 and the image data from camera 10 as input and calculates the average values of image data for each pixel. FIFO memory 20 and calculator 30 compose a calculating part.

The image data from calculator 30 are subjected to graphic data compression by Web server 40 and are output from Web server 40 to a network. National Television System Committee (NTSC) encoder 50 converts image data from calculator 30 to NTSC data and outputs them to a monitor.

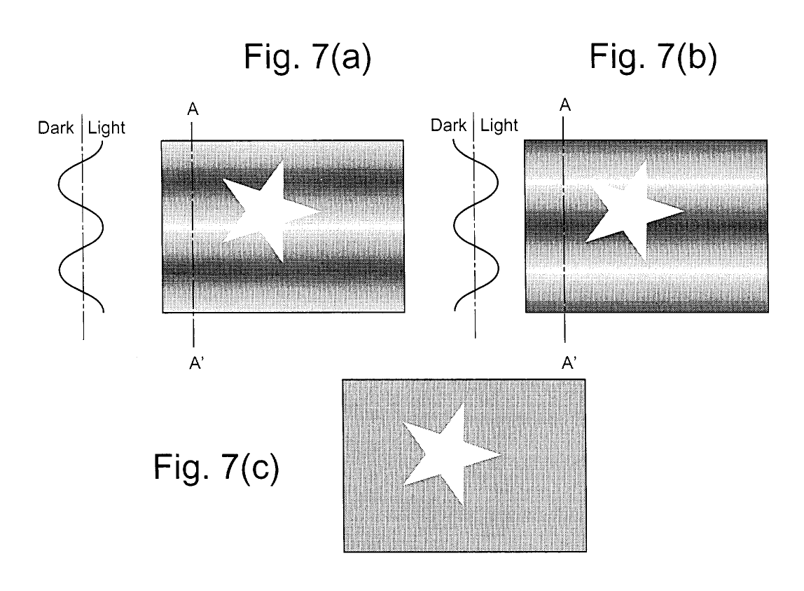

The operation of such a system will be described below. FIG. 7 is a drawing illustrating the operation of the system shown in FIG. 6. In FIG. 7, (a) shows image data of the present frame, (b) shows image data of the frame by one frame before the present frame, and (c) shows image data as the result of calculation in calculator 30.

Camera 10 picks up the image of a photographic subject not shown in the drawing, creates RGB data, carries out video signal processing to these RGB data, such as color interpolation, color adjustment, color matrix adjustment, etc., converts these data to 16-bit YCrCb (luminance and phase) image data and outputs them.

FIFO memory 20 receives these YCrCb image data as input-and outputs them, delaying them by one frame. Calculator 30 calculates the average values of luminance and color signals for each pixel using the present YCrCb image data from camera 10 and one frame-delayed YCrCb data from FIFO memory 20. In other words, two kinds of luminance along the axes A-A′ in FIG. 7 (a) and FIG. 7 (b) change approximately sinusoidally. Then, sinusoidal luminance changes due to flickering are almost canceled out by calculating average values of image data in FIG. 7 (a) and image data in FIG. 7 (b), thus image data shown in FIG. 7 (c) can be obtained.

Results of calculation in calculator 30 are subjected to Joint Photographic Experts Group (JPEG) type compression, Moving Picture Experts Group (MPEG) type compression, or the like by Web server 40 and then they are output from Web server 40 to a network In addition, NTSC encoder 50 converts the calculation results to NTSC data and outputs them to a monitor.

As described above, since calculator 30 calculates the average values of image data, which generates lateral stripes due to flickering, and the phases of which are approximately shifted by about 180 degrees from each other, and adopts the results of such calculation as actual image data, the influence of flickering can be suppressed.

(Second Embodiment)

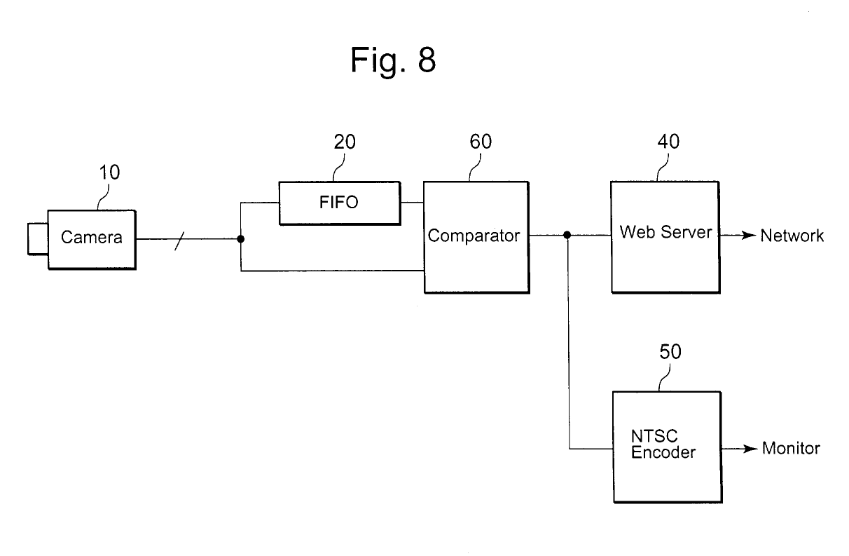

Next, a second embodiment will be described below. FIG. 8 is a configuration drawing indicating a second embodiment of the present invention. In FIG. 8, the components identical to those in FIG. 6 are given the same signs and their description is omitted.

In FIG. 8, comparator 60 is provided in lieu of calculator 30 and compares image data of FIFO memory 20 with image data of camera 10 for each pixel, adopts the data which has higher luminance as the image data, and outputs them to Web server 40 and NTSC encoder 50. In FIG. 8, FIFO memory 20 and comparator 60 compose a comparing part.

In operations of such a system, comparator 60 compares image data for each pixel and larger luminance data are adopted as the image data. As a result, differences between darkness and light become small, and thus the influence of flickering causing lateral stripes can be reduced. Since other operations are the same as those in the first embodiment, their description is omitted.

(Third Embodiment)

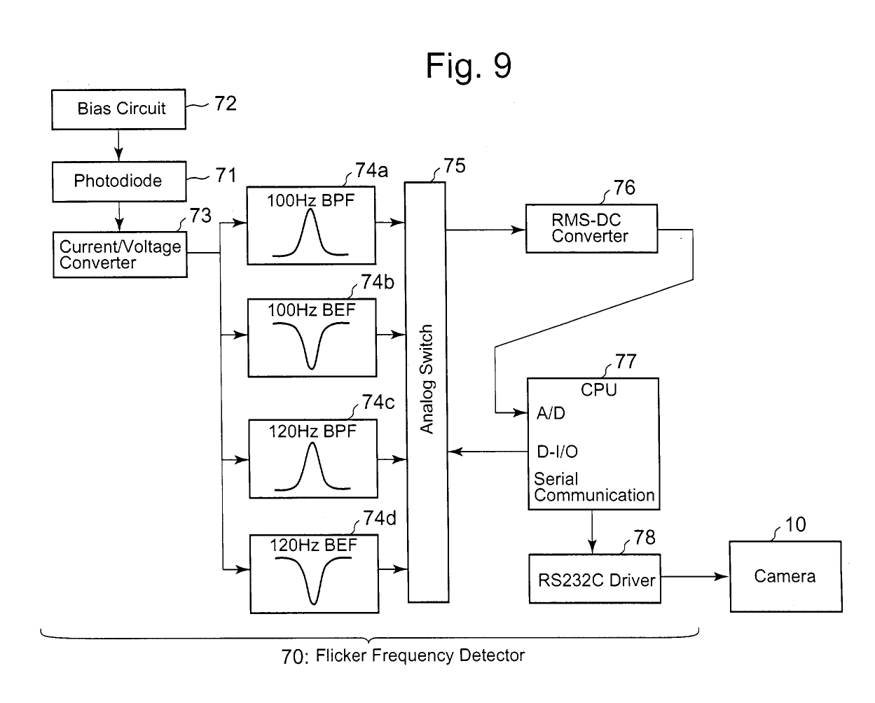

Next, a configuration in which the generation of flickering is detected and the frame rate, at which image data the phases of which are shifted by approximately 180 degrees relative to each other, is selected automatically, will be described using FIG. 9. In FIG. 9, the components identical to those in FIG. 6 are given the same signs and both their description and their indication in the drawing are omitted.

In FIG. 9, flicker frequency detector 70 detects flickering in cases where illuminating light is 100 Hz (power supply frequency of 50 Hz in East Japan) or 120 Hz (power supply frequency of 60 Hz in West Japan) and outputs the detected results to camera 10. Flicker frequency detector 70 comprises photodiode 71, bias circuit 72, current/voltage converter 73, band pass filter (BPF) 74a, band elimination filter (BEF) 74b, BPF 74c, BEF 74d, analog switch 75, RMS-DC converter 76, CPU 77 and RS-232C driver 78.

Photodiode 71 receives a bias voltage of bias circuit 72 and also receives the incident illuminating light. Current/voltage converter 73 converts the current output from photodiode 71 to a voltage. Thus, photodiode 71, bias circuit 72, and current/voltage converter 73 compose a photo-sensor that receives the illuminating light as input and detects flickering.

BPF 74a receives the output of current/voltage converter 73 as input and permits signals in the vicinity of 100 Hz to pass. BEF 74b receives the output of current/voltage converter 73 as input and does not pass signals in the vicinity of 100 Hz. BPF 74c receives the output of current/voltage converter 73 as input and permits signals in the vicinity of 120 Hz to pass. BEF 74d receives the output of current/voltage converter 73 as the input and does not pass signals in the vicinity of 120 Hz.

Analog switch 75 selects the output of BPF 74a, BEF 74b, BPF 74c, and BEF 74d in turn. RMS-DC converter 76 receives the output of analog switch 75 as input and outputs an RMS (effective) value. CPU 77 changes over the selection of analog switch 75, receives the output of RMS-DC converter 76 as input, judges the frequency of the illuminating light using the output of the RMS-DC converter, and outputs the result of the judgment. CPU 77 has a control means, A/D conversion means, calculation means, and judgment means. RS-232C driver 78 outputs the result of judgment by CPU 77 to camera 10 using serial communication. Analog switch 75, RMS-DC converter 76, CPU 77, and RS-232C driver 78 compose the judgment part for judging flickering.

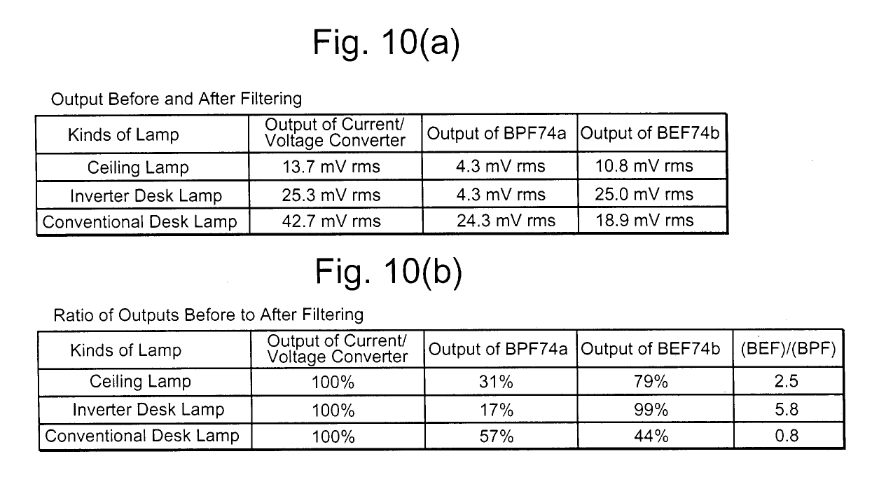

Operation of such a system will be described below. FIG. 10 is a drawing illustrating the operation of the system shown in FIG. 9, and (a) shows the output before and after filtering and (b) shows the ratios of output before filtering to output after filtering.

Photodiode 71 outputs a current according to illuminating light. This current is converted to a voltage by current/voltage converter 73. The voltage is filtered by BPF 74a, BEF 74b, BPF 74c, and BEF 74d, then output to analog switch 75 respectively. Analog switch 75 in turn selects BPF74a, BEF 74b, BPF 74c, and BEF 74d as directed by the control means of CPU 77. RMS-DC converter 76 converts the output from analog switch 75 to RMS values and outputs them to CPU 77. CPU 77 converts analog signals from RMS-DC converter 76 to digital signals using the A/D converting means and holds each value of outputs from BPF 74, BEF 74b, BPF 74c, and BEF 74d. In other words, values shown in FIG. 10 (a) are held. In this case, the outputs from BPF 74c and BEF 74d are omitted.

CPU 77 determines ratios, (output of BEF 74b)/(output of BPF 74a) and (output of BEF 74d)/(output of BPF 74c) using the calculation means as shown in FIG. 10 (b). Since cases where flickering is a problem are those in which illuminating light flickers with a frequency of 100 Hz or 120 Hz not containing large harmonics, it can be determined that, if the ratio is lower than 1:1, the light causes flickering and if the ratio is higher than 1:1, the light does not cause problems. Accordingly, CPU 77 judges that, in FIG. 10 (b), the ceiling lamp and the inverter desk lamp, for which the ratio (output of BEF 74b)/(output of BEF 74a) is 2.5 and 5.8 respectively, emit non-flickering light and the conventional desk lamp, for which the above ratio is 0.8, emits flickering light.

As a result, CPU 77, if it judges a given light to cause flickering, gives output indicating which light of either 100 Hz or 120 Hz causes the flickering to RS-232C driver 78. RS-232C driver 78 then notifies camera 10 of the result using serial communication. In this case, RS-232C driver 78 notifies camera 10 of the 100 Hz light. Camera 10 changes the setting to a frame rate, at which such images are obtained that the illuminating light has 100 Hz, and the phase that generates lateral stripes of flickering has relations shifting about 180 degrees in every frame. Since other operations are identical to those of the system shown in FIG. 6, their description is omitted.

As described above, illuminating light is input using photodiode 71 and the output of photodiode 71 is passed through BPF 74a, BEF 74b, BPF 74c, and BEF 74d. Then the ratios (output of BEF 74b)/(output of BPF 74a) and (output of BEF 74d)/(output of BPF 74c) are determined and it is judged which light is causing the flickering. Accordingly, camera 10 can automatically set the frame rate using the results of this judgment.

A configuration in which BPF 74a and BPF 74c are separately provided, and a configuration, in which BEF 74b and BEF 74d are separately provided, are indicated above. However, a configuration in which a BPF that permits the frequencies in the vicinity of 110 Hz to pass and a BEF that eliminates the frequencies in the vicinity of 110 Hz may be employed to reduce the size of the circuit to half. In this case, it is required to employ a configuration in which the power supply frequency of 50 Hz or 60 Hz is set or detected to or by camera 10 in advance, because whether flickering is caused or not can be judged, but whether the flickering is caused by 100 Hz or 120 Hz cannot be identified. The reason for this is that the frame rate to be set by camera 10 is different for 50 Hz and 60 Hz.

Further, although the configuration in which camera 10 automatically sets the frame rate is shown above, a configuration such that the frame rate is set in advance, and calculator 30 takes a measure against flickering or not by inputting the result of the judgment by CPU 77 to calculator 30, may be employed.

In addition, although the configuration in which camera 10 sets a frame rate that brings the relationship of image data shifted about 180 degrees for every frame is shown above, a flicker-suppressing configuration, in which camera 10 sets a frame rate at which lateral stripes of flickering stop, may be employed.

As prior arts for the third embodiment, there are Publication of Japanese Laying Open of Patent Application No. 5-56437, Publication of Japanese Laying Open of Patent Application No. 7-264465, and others.

(Fourth Embodiment)

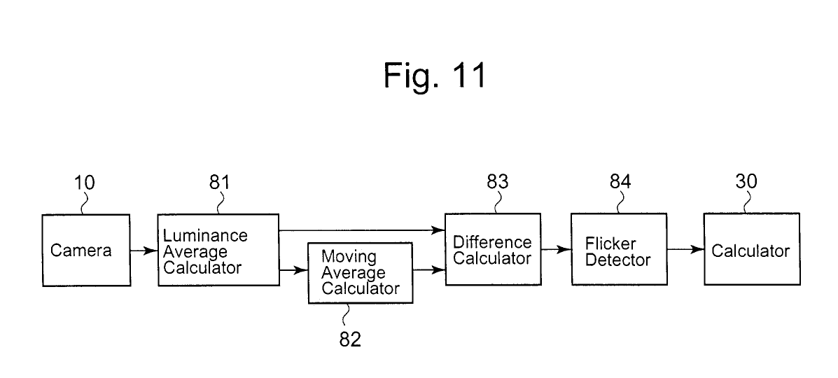

A fourth embodiment for detecting generation of flickering and suppressing same will be described in reference to the embodiment in FIG. 11. In FIG. 11, the components identical to those in FIG. 6 are given the same signs and both their description and their indication in the drawing are omitted.

In FIG. 11, luminance average calculator 81 receives image data from camera 10 as input and calculates the luminance average of the desired line. Moving average calculator 82 calculates the moving average using the luminance average value in luminance average calculator 81. Difference calculator 83 calculates the difference between the luminance average value in luminance average calculator 81 and the moving average value in moving average calculator 82. Flicker detector 84, judges flickering using the difference value in difference calculator 83 and notifies calculator 30 of flickering.

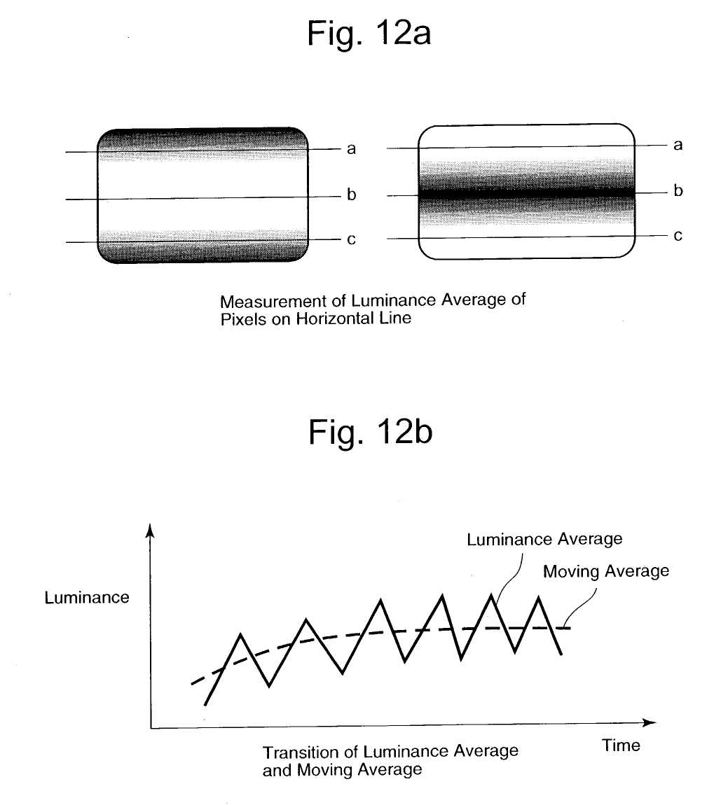

Operation of such a system will be described below. FIG. 12 is a drawing illustrating the operation of the system shown in FIG. 11, (A) in FIG. 12 shows an illustration of measuring the line luminance average, and (B) in FIG. 12 shows the transition of line luminance average and moving average over time.

Camera 10, set to output image data in which the phases that generate lateral stripes of flickering are shifted about 180 degrees to each other in every frame, outputs the image data shown in FIG. 12 (A). Luminance average calculator 81 calculates the luminance average in the desired lines ‘a’ to ‘c’. Using this luminance average, moving average calculator 82 calculates the moving average. Next, difference calculator 83 calculates the difference between the luminance average value in luminance average calculator 81 and the moving average value in moving average calculator 82 and outputs this difference to flicker detector 84. Flicker detector 84 identifies flickering if the difference values repeat the positive and negative values, for example, shown in FIG. 12 (B) and notifies calculator 30 of the flickering. By this notification, calculator 30 calculates the average values of luminance and color signal for each pixel using the present YCrCb image data from camera 10 and the one frame-delayed YCrCb image data from FIFO memory 20. If flicker detector 84 does not identify flickering, calculator 30 does not operate because no notification is given. Since other operations are already shown above, description of those operations is omitted.

As mentioned above, since luminance average calculator 81 determines the luminance average of image data, moving average calculator 82 determines the moving average using this luminance average, difference calculator 83 determines the difference between the luminance average value in luminance average calculator 81 and the moving average value in moving average calculator 82, and flicker detector 84 identifies flickering using this difference, flickering can thus be automatically detected. That is, since image data are not composed if there is no flickering, data without an afterimage can be obtained, while if there is flickering, flickering can be suppressed.

Further, the present invention is not limited to the above. Calculator 30 determines the average values of luminance and color signal in the above description. This is because, since image data comprise the YCrCb image, luminance for RGB data affects color signals when RGB data are converted to YCrCb data. In other words, if camera 10 outputs RGB data, it is sufficient that calculator 30 determines the average values of luminance only.

Calculator 30 may be configured so that average values are calculated only for pixels for which at least either one side image data that are to be compared have a predetermined degree of luminance or more luminance. This enables prevention of flickering only for portions where flickering is generated, and thus afterimages due to composition of image data in the portions where flickering is not generated can be suppressed.

Further, calculator 30 may be configured so that the image data having higher luminance are selected for pixels for which at least either one side image data that are to be compared have a predetermined degree of luminance or more luminance, and for other pixels average values are calculated. This is because, for a predetermined degree of luminance or more luminance, light and darkness do not show sinusoidal waves as shown in FIG. 7. For a predetermined degree of luminance or more luminance, the influence of flickering can be prevented by selecting higher luminance.

Although the configuration is shown above, in which comparator 60 selects image data having higher luminance as the image data, a configuration in which comparator 60 selects image data having lower luminance may be chosen.

Further, another configuration may be selected, in which comparator 60 selects pixels for the image data having higher luminance when at least either one side image data that are to be compared have a predetermined degree of luminance or more luminance, and pixels not selected show image data immediately before, that is, image data from camera 10. This configuration can prevent flickering for the data having a predetermined degree of luminance or more luminance because the influence of flickering is large for the predetermined degree of luminance or more luminance, and can also supply the latest image data for other data having luminance less than the predetermined value.

In addition, although the configuration in which camera 10 outputs image data generating lateral stripes of flickering and having a phase shifted about 180 degrees for each frame, every two or more frames may also be adopted in lieu of every single frame.

What is claimed is:

1. A camera system comprising:
a photographing part which generates image data from image sensors using the rolling shutter method, and
a calculating part which receives image data from said photographing part as input, calculates average values of the image data, which generate lateral stripes of flickering the phases of which are shifted about 180 degrees relative to each other, for each pixel, and the calculated results are employed as the image data.

2. A camera system in accordance with claim 1, wherein said calculating part at least calculates the average values of luminance.

3. A camera system in accordance with claim 1 or claim 2, wherein said calculating part really calculates the average values only for pixels for which either one side image data of the two the average values of which are to be calculated, have a predetermined degree of luminance or more luminance.

4. A camera system in accordance with claim 1 or claim 2, wherein said calculating part selects the image data having higher luminance for pixels for which either one side image data the average values of which are to be calculated, have a predetermined degree of luminance or more luminance, and for the other pixels, the average values are calculated.

5. A camera system in accordance with any of claims 1 to 4, wherein said calculating part comprises:
a temporary memory that receives the image data in said photographing part as inputs and stores them temporarily, and
a calculator that receives the image data in this temporary memory and the image data in said photographing part as input and at least calculates the average values of the image data.

6. A camera system comprising:
a photographing part generating image data from image sensors using the rolling shutter method, and
a comparing part that receives the image data in said photographing part as input, compares luminance of image data, which generate lateral stripes of flickering and the phases of which are shifted about 180 degrees relative to each other, for each pixel, and selects image data using the compared results.

7. A camera system in accordance with claim 6, wherein said comparing part, when either one of the image data to be compared shows a pixel having a predetermined degree of luminance or more luminance, selects the pixel with image data of higher luminance, and the pixels not selected are employed as the image data taken immediately before.

8. A camera system in accordance with claim 6 or claim 7, wherein said comparing part comprises:
a temporary memory that receives image data from said photographing part as input and stores them temporarily, and
a comparator that compares the image data in the temporary memory with the image data in said photographing part and selects image data using the compared results.

9. A camera system in accordance with any of claims 1 to 8, comprising:
a photo sensor that receives the incident illuminating light,
at least one band pass filter to which the output of said photo sensor is input,
at least one band elimination filter to which the output of said photo sensor is input, and
a judging part that judges flickering using the output of said band pass filter and the output of said band elimination filter;
and suppressing flickering using the result of the judgment by said judging part.

10. A camera system comprising:
a photo sensor that receives the incident illuminating light,
at least one band pass filter to which the output of said photo sensor is input,
at least one band elimination filter to which the output of said photo sensor is input, and
a judging part that judges flickering using the output of said band pass filter and the output of said band elimination filter, and
a photographing part that adjusts the frame rate using the result of the judgment by said judging part and generates image data from image sensors using the rolling shutter method.

11. A camera system in accordance with any of claims 1 to 8, comprising:
a luminance average calculator that receives image data from said photographing part as input and calculates the luminance average of the desired line,
a moving average calculator that calculates moving average using the luminance average value from said luminance average calculator,
a difference calculator that calculates the difference between said luminance average value from said luminance average calculator and the moving average value from said moving average calculator, and
a flicker detector that judges flickering using said difference value obtained by said difference calculator;
and suppressing flickering using the judgment by said flicker detector.

12. A camera system in accordance with any of claims 1 to 11, wherein image sensors are CMOS sensors.
